(19) United States
(12) Patent Application Publication
(10) Pub. No.: US 2015/0379033 A1
(43) Pub. Date: Dec. 31, 2015

(54) PARALLEL MATCHING OF HIERARCHICAL RECORDS

(71) Applicant: INTERNATIONAL BUSINESS MACHINES CORPORATION, Armonk, NY (US)

(72) Inventors: Manoj K. Agarwal, Noida (IN); Amitava Kundu, Bangalore (IN); Rajesh Sambandhan, Bangalore (IN); Mangesh V. Shanbhag, Bangalore (IN)

(21) Appl. No.: 14/317,136

(22) Filed: Jun. 27, 2014

(51) Int. Cl. G06F 17/30

(52) U.S. Cl. CPC G06F 17/30106; G06F 17/30371; G06F 17/30589

(57) ABSTRACT

Identifying matching transactions between two log files. First and second log files contain operation records of transactions in a transaction workload. The first and second log files are split into first and second corresponding partition files, based on distinct sequences of operation record types beginning operation records of the transactions in each of the log files. A record location in a first partition file, and a window of sequential record locations in a corresponding second partition file at a defined offset relative to the record location in the first file are advanced one record location at a time. If each operation record of a complete transaction at a record location in a first file has a matching record in the associated window of record locations in a second file, the corresponding transactions match.

### BACKGROUND

The present invention relates generally to identifying matching multi-level transaction records between log files, and more particularly to performing a partitioning operation prior to performing a matching operation.

Databases are routinely upgraded to new versions, or new software patches are applied on existing versions, or the database is migrated to a new database management system. In each of these situations, it is common to compare the performance of a benchmark transaction workload in the new database environment to the same benchmark transaction workload in the old database environment. A benchmark transaction workload is typically a sequence of different transaction types. In a typical database environment, each transaction, for example, may be a sequence of one or more Structured Query Language (SQL) statements. To compare the performances of the benchmark transaction workloads, corresponding instances of transactions in the new and old database environments are matched.

Typically, database transactions are multi-level transactions. That is, each transaction can include several SQL statements. In addition, while the SQL log records of a transaction will usually appear in the proper order in a database transaction log file, the database operation records from multiple transactions can be intermixed. Further, the different executions of a transaction workload will typically result in different sequences of database operation log file records. These factors can complicate matching of transactions between database transaction log files.

### SUMMARY

Embodiments of the present invention disclose a method, computer program product, and system for identifying matching transactions between two log files. First and second log files contain operation records recording executions of operations of transactions in a transaction workload. Each operation record has an associated operation record type, and each file records a respective execution of the transaction workload. The first and second log files are split into pluralities of corresponding respective first and second partition files, based on distinct sequences of operation record types of a first number of beginning operation records of the transactions in each of the log files. A first record location in a first partition file, and a window of a defined number of sequential second record locations in a corresponding second partition file at a defined record location offset relative to the first record location in the first file, are advanced one record location at a time. It is determined whether each operation record of a complete transaction at a first record location has a matching operation record at one of the record locations in the associated window of second record locations. In response to determining that each operation record of a complete transaction at a first record location has a matching operation record in the associated window of second record locations, identifying, the complete transaction in the first partition file and the transaction that includes the matching operation records in the corresponding second partition file as matching transactions.

### BRIEF DESCRIPTION OF THE SEVERAL VIEWS OF THE DRAWINGS

FIG. 1 is a functional block diagram illustrating a transaction matching system, in accordance with an embodiment of the present invention.

FIG. 2 is a functional block diagram illustrating a log file partitioning module in the benchmark analysis system of the transaction matching system of FIG. 1, in accordance with an embodiment of the present invention.

FIGS. 3A-3D is a flowchart depicting the steps that a log file partitioning module in the benchmark analysis system of the transaction matching system of FIG. 1 may execute, in accordance with an embodiment of the invention.

FIG. 4 is a block diagram of a transaction matching module in the benchmark analysis system of the transaction matching system of FIG. 1, in accordance with an embodiment of the present invention.

FIGS. 5A and 5B are a flowchart depicting the steps of a transaction matching algorithm, in accordance with an embodiment of the present invention.

FIG. 6 is a block diagram of components of the computing device of the transaction matching system of FIG. 1, in accordance with an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention operate within an environment in which transactions in a first log file, the “replay” log file, are matched to transactions in a second log file, the “capture” file. In various embodiments, one or more partitioning operations first partition the capture and replay log files based on the SQL records in the transactions. In an embodiment, the log files are split into partition files based on the first SQL records in each transaction. Thus, there may be multiple partition files, each containing transaction records for transaction that have the same first SQL record type. Partition files with, for example, record counts above a threshold value may be further partitioned based on the second SQL record types of the transactions in the files.

After the petitioning operations, matching logic steps down corresponding capture and replay log files substantially synchronously, and for each transaction record in the replay file, attempts to identify the corresponding record in the capture file. Because the two log files will typically not align record for record, a match window is defined in the capture file, relative to each record in the replay file, within which a match to the replay record is expected to be found. If the match window is very large, the likelihood of finding a match to a capture file record within the match window of the replay file is high. However, the computing resources required to perform the matching logic and maintain the large match window will be correspondingly high. If the match window is small, the computing resources required to perform the matching logic and maintain the small match window will be correspondingly small, but the likelihood of finding a match within the match window may be unacceptably low. In certain embodiments of the invention, the match window is dynamically adjusted as matching operations progress, to satisfy a predetermined acceptable likelihood.

As will be described in more detail below, for a given pair of capture and replay log files, the overall processing time required to perform the matching operations is proportional to the square of the size of the match window, and the size of the match window is proportional to the number of records in a log file. Large log files may cause the computer performing the matching operations to exhaust memory and abort. In certain embodiments, recursive partition operations are performed until, for example, the record counts in all partition files are below a threshold value.

An exemplary environment in which the present invention may operate is described in U.S. patent application Ser. No. 13/483,778 to Agarwal, et al. (“Agarwal1”) [IN920120004US1], which is hereby incorporated by reference in its entirety. Another exemplary environment in which the present invention may operate is described in U.S. patent application Ser. No. 13/772,386 to Agarwal, et al. (“Agarwal2”) [IN920120117US1], which is hereby incorporated by reference in its entirety. However, embodiments of the present invention are not limited to operating in such exemplary environments and may be utilized wherever matching records are to be identified between files, subject to certain constraints and assumptions which may include ones described herein.

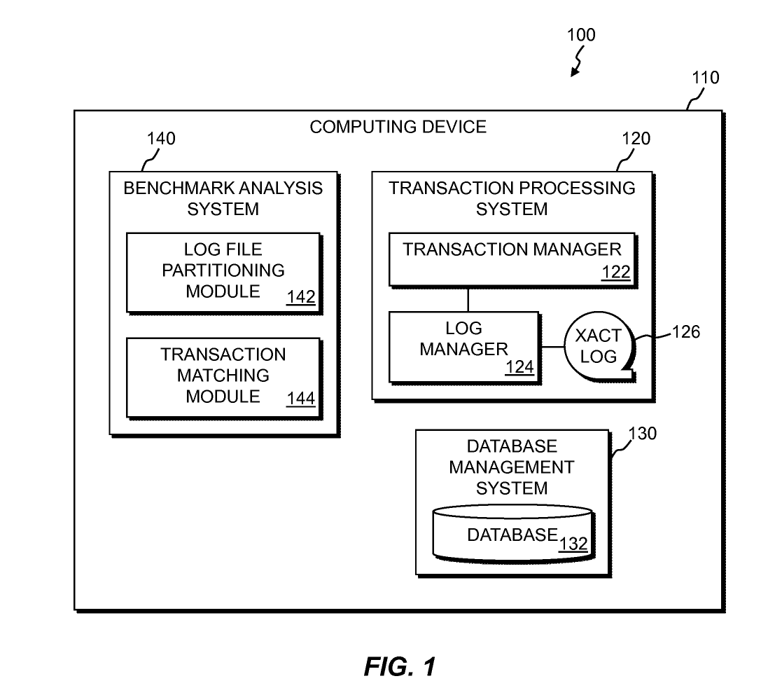

FIG. 1 is a functional block diagram illustrating a transaction matching system 100 in accordance with an embodiment of the present invention. Transaction matching system 100 includes computing device 110, which further includes transaction processing system 120, database management system 130, and benchmark analysis system 140.

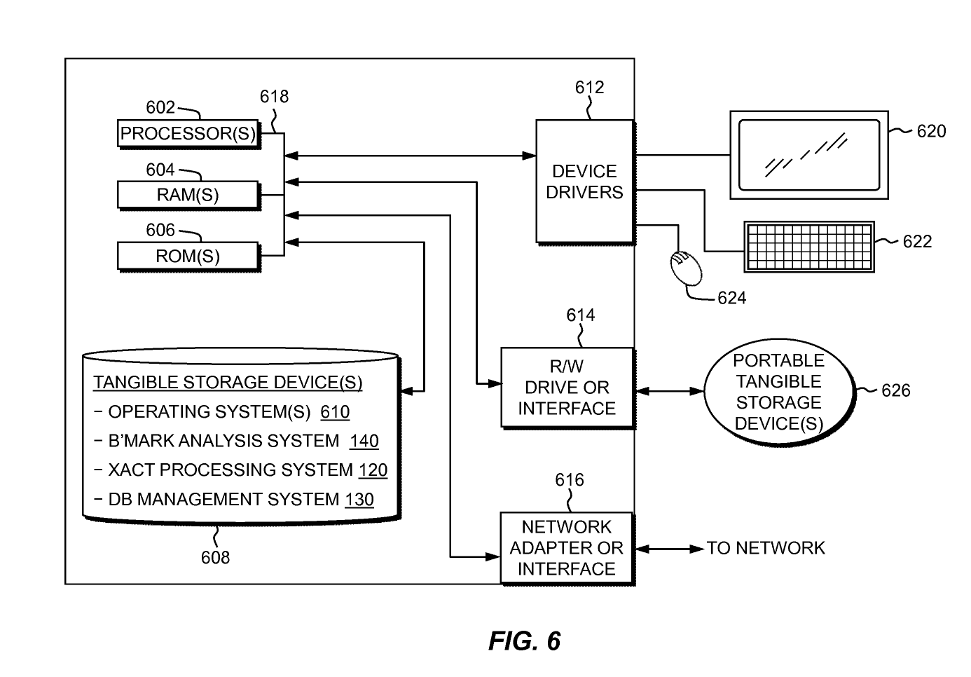

In various embodiments of the invention, computing device 110 can be, for example, a mainframe or mini-computer, a laptop, or netbook personal computer (PC), or a desktop computer. Transaction matching system 100 is shown as being wholly implemented on computing device 110. However, transaction matching system 100 may operate in a distributed environment in which one or more of its components are implemented across a plurality of computing devices that communicate over a network, such as a local area network (LAN) or a wide area network (WAN) such as the Internet. For example, benchmark analysis system 140 may operate on a separate computing device. In general, transaction matching system 100 can execute on any computing device 110, or combination of computing devices, in accordance with an embodiment of the invention, and as generally described in relation to FIG. 6.

Transaction processing system 120 includes transaction manager 122, log manager 124, and transaction log file 126. Transaction manager 122 manages the processes that execute transactions against database 132 via database management system 130. Transaction manager 122 also manages all transactions so as to maintain data consistency in database 132. This is accomplished through the use of log manager 124. Log manager 124, among its other activities, records each transaction operation of a transaction workload, such as the execution of SQL statements in a transaction, in a transaction operation record to transaction log file 126.

Database management system 130 includes database 132, which may reside, for example, on tangible storage device(s) 608 (see FIG. 6). Database management system 130 manages access to database 132, and manages the resources associated with database 132, such as disk space.

Benchmark analysis system 140 operates generally to analyze different executions of a benchmark transaction workload, and provide systems and applications programmers and systems administrators information to determine, for example, the most efficient organization of a database 132, or of a transaction workload, or for determining the most efficient database management system 130 or transaction processing system 120. The information that benchmark analysis system 140 processes is derived from one or more transaction log files 126. For example, the transaction log file 126 information pertaining to two different executions of a benchmark transaction workload are stored on disk, such as tangible storage device 608, after each benchmark workload completes, and this information is made available to benchmark analysis system 140 for analysis.

Benchmark analysis system 140 includes log file partitioning module 142, and transaction matching module 144. Benchmark analysis system 140 operates generally to identify matching transactions between different executions of a benchmark transaction workload. Log file partitioning module 142, the operation of which will be described in more detail below, operates generally to partition, or split out, the log files into smaller partition files. In one embodiment, a capture and a replay log file are each partitioned based on the first SQL records in each transaction.

Transaction matching module 144, the operation of which will be described in more detail below, operates generally to identify matching transactions between all corresponding capture and replay partition files. For example, in an embodiment, the capture log file and the replay log file at least contain transaction records for the same benchmark transaction workload. When the capture log file is partitioned by file partitioning module 142, each partition file will contain only a set of transactions beginning with the same distinct sequence of SQL records. Depending on the level of partitioning, the sequence may be a single SQL record, or several SQL records. Similarly for the partition files of the replay log file. Transaction matching module 144 identifies matching transactions between corresponding partition files of different executions of a benchmark transaction workload. These matching transactions may then be further analyzed by benchmark analysis system 140 to provide useful information to, for example, systems and applications programmers and systems administrators.

Embodiments of the invention are described with respect to the components and their functionality as presented in FIG. 1. Other embodiments of the invention may perform the invention as claimed with different functional boundaries between components. For example, the functionality of transaction matching module 144 may be implemented as a standalone component, or as a function of transaction processing system 120.

In embodiments of the invention, various constraints and assumptions apply. One constraint is that although the same benchmark transaction workload may be executed twice in the same database environment, or different database environments, the transaction log files 126 of these executions may be different for several reasons. For example, the SQL records for transactions executed sequentially may be interleaved in a different order in different executions of the same transaction workload. There may also be other transaction workloads executing on the database systems that produce extraneous log records that will be intermixed in the transaction log file 126 with the benchmark transaction workload records.

One operating assumption is that a record in the replay file will find a match in the capture file, if there is a match, within a certain range or “match window”. This assumption serves to recognize that records can be out of order between the capture and replay files, and that there may be extraneous records in the replay file for which there is no matching record in the capture file, and vice-versa. The assumption also serves to limit, or bound, the number of compare operations and thus limit the computer resources consumed by the compares. The trade-off for this assumption is that if there is a capture record outside of the match window that does match the current replay record, this match will not be found and the replay record will be flagged as extraneous. Similarly, it is assumed that a record in the capture file will find a match in the replay file, if there is a match, within the same range or “match window” of replay file records.

Another assumption is that all SQL records for a transaction will appear in a transaction log file 126 in the order of execution within the transaction, even though the SQL records of one transaction may be interleaved with the SQL records of another transaction. Thus, if an end-of-transaction SQL record appears in transaction log file 126, then no other SQL record for this transaction will appear in the transaction log file following the end-of-transaction record.

A benchmark transaction workload typically includes a sequence of database transactions. Each database transaction will typically comprise, for example, a sequence of SQL statements. When a series of database transactions are executed, for example, by transaction processing system 120, the SQL statements of a transaction are typically executing in an interleaved manner with the SQL statements of other database transactions of the benchmark transaction workload. Thus, although the database transactions may execute in sequence, their underlying SQL statements can be interleaved with SQL statements of other transactions, and the corresponding transaction log file 126 records will be similarly interleaved. Further, different executions of the same benchmark transaction workload can produce different execution sequences of the underlying SQL transactions. This could be due to such factors as I/O scheduling by the operating system, I/O delay, network delay, locking and latching within the database, etc. Although the execution of the underlying SQL statements of different transactions may be interleaved, the SQL statements in a given transaction will execute in order, and will appear in the transaction log file 126 in order.

A benchmark transaction log file 126 may also contain extraneous SQL records. These are records in the capture file that cannot be matched to records in the replay file, and vice-versa. Extraneous records may result from transactions executing in a database environment that are not part of the benchmark transaction workload.

With respect to SQL statement matching, each SQL statement is considered an ordered sequence of tokens. SQL records in the transaction log files 126 are compared token by token rather than comparing SQL records as complete character strings. A SQL token is a word or character that can be identified meaningfully when the SQL statement is parsed, or interpreted. For example, each token can typically be considered a keyword, an identifier, a quoted identifier, a constant, or one of several special character symbols. SQL statement clauses can include several tokens. Token by token comparisons allow for meaningful determinations of partial matches, and identifications of complete matches, even though not all corresponding token values are identical. For example, there might be some differences in the host variables between log files. If the only difference between two SQL records is differences in the host variables, this could be considered a high-scoring partial match. In certain embodiments of the invention, token matching is done in a Boolean manner, i.e., either a pair of corresponding tokens match exactly or they don't match at all. For instance, there is no partial matching between two tables named “Order” and “Orders”. This token based string comparison also helps to remove the differences that arise due to change in comments, change in schema name, etc. For example, comments can be ignored or stripped from the record during the compare step.

An assumption with regard to SQL record matching is that if a replay SQL record partially matches a capture SQL record, and the SQL record includes multiple host variables, then at least one of the host variables in the matching records should match. This assumption is one way to increase the likelihood that a partial match between a replay transaction and a capture transaction with a match score above the match score threshold is in fact an actual match. If the potentially matching records do not have a common host variable, then a mismatch is declared.

In certain embodiments of the invention, the similarity between two SQL records is determined by assigning a numerical value to a match score. For example, if all tokens of a SQL record match those of another, the match score is 1. If no tokens match, the match score is 0. If the first token, which will typically be the statement or command type, doesn't match, then the entire record may be considered as not matching. A partial match score can be based, for example, on the percentage of tokens that match. If most tokens match, except for host variable tokens, a percentage increase may be added to the match score. In certain embodiments a match score threshold is defined, below which a mismatch is declared. For example, a match threshold of 80% may be defined. Because a transaction workload often involves repeating sequences of transactions, it is possible that a replay file record may partially match more than one capture file record with a match score above the mismatch threshold.

With respect to transaction matching generally, a capture transaction will match a replay transaction if all the SQL records of the capture transaction match all the SQL records of the replay transaction. However, as stated above, partial matching of SQL records is possible. Thus, if a replay transaction has more than one potential matching capture transaction, the capture transaction with the highest match score is considered the best match. For example, the capture transaction having the greatest sum of SQL record match scores with relation to a specific replay transaction is considered the best candidate for a transaction match.

As mentioned above, embodiments of the invention use a match window as an assumption to limit the number of records that are compared in the capture file to a replay file record. The capture file match window is expressed as a 2K+1 window, where K is the number of records searched before and after the capture file record that corresponds to the replay record that is being matched. For example, if capture records having log file index locations 80 to 120 are searched for a match to a replay record at log file index location 100, K equals 20 and the match window is 41 records. Generally, embodiments of the invention step down the replay file one record at a time, and search the corresponding match window in the capture file for matching records. If a matching capture file record is not found in the match window, the replay record is marked as extraneous. If the match window advances beyond a capture file record that has not been matched, the capture file record is considered extraneous. In certain embodiments of the invention, the match window is not centered on the corresponding record number of the record being read in the replay file, but is a fixed offset number of records away. In a preferred embodiment, the match window is implemented as a circular buffer with a length of 2K+1.

In one embodiment of the invention, the match window is dynamically adjusted by either increasing or decreasing the window size. The match window may be initially set to a predetermined number, or span, of records such that the likelihood of finding a match to a replay file record within the match window of the capture file is high. This predetermined number of records may be much larger than the window size that is dynamically converged to. Then, after each set of a predetermined number of matches is found between the log files, the maximum distance in records between matching records in the set is determined, and the window size, or span, is adjusted based on this maximum distance. If a sudden increase in the number of unmatched records in the capture file as a percentage of capture records read is detected, this may indicate that the current match window size is too small, and the window size can be increased. This is described in more detail below.

With respect to window size, empirical data indicates that the processing time to identify matches between a pair of log files to compare with a match window of size K is proportional to at least K². The data also indicates that as each pair of files are partitioned based on unique SQL sequences, the required match window size K reduces approximately in proportion to the decrease in file size. For example, if a replay file being processed for matching transactions against a capture file requires a match window size of K for a level of acceptable results, if partitioning of the pair of files results in a partitioned replay file of half the original replay file size, the match window size for a comparable level of acceptable results is approximately K/2, or half the original match window size. Therefore, the processing time to identify matches between a pair of partitioned files that are half as large as the original files is proportional to (K/2)² as compared to a processing time To required for the original-sized files. However, because there are two sets of partitioned files, the total processing time to identify matches will be proportional to 2·(K/2)². Based on this, the total processing time to identify matches between a pair of files that has M sets of partitioned files, each of size 1/M of the original file size, is proportional to M·(K/M)².

Based on this, an estimate of the reduction in total processing time between a pair of un-partitioned files and the same files partitioned may be expressed as the ratio K²:M·(K/M)²), which may be further reduced to the ratio 1:1−(1/M). Thus, for a pair of log files in which to identify matching transactions that has 10 sets of partitioned files, each 1/10 as large as the original un-partitioned files, it may be expected that there will be a 90% reduction in total processing time.

However, for each partitioning operation, there is a certain amount of processing overhead. This overhead may be estimated to be proportional to the size of the file to be partitioned. Based on the above, as each log file is partitioned, the size of the file decreases by a factor of M. Thus, for example, the first partitioning operation may take a processing overhead S; the second partitioning operation may take a processing overhead n·S; the third partitioning operation may take a processing overhead n²·S, and do on. This may be expressed more generally as S·(1+n+n²+ . . . ), or S·Σn^{k}, where S is the processing overhead required to perform the partitioning operation on the original un-partitioned log file, and n is the fractional size of the largest partition among all the partitioned files. Since n represent the fractional size of the largest partitioned file with respect to the original file, 0<n≦1. Hence, the summation may be further reduced to S·(1/(1−n)). Based on this, a more refined estimate of the total processing time to identify matches between a pair of partitioned log files may be expressed as T₀·(1−(1/M))+S·(1/(1−n)). The first term, which represents the processing time to perform the matching operations, decreases as the number of partitions increases; the second term, which represents the overhead time to perform the partitioning operations, increases as the number of partitioning operations increases. Therefore, if the reduction in processing time to perform the matching operations resulting from partitioning to a certain level is greater than the increase in overhead to perform the partitioning, it may be worthwhile to partition the original files to that level. Based on the two terms forming the total processing time, a minimum total processing time may occur for a given pair of log files to compare at a certain level of partitioning.

The analysis above provides a rough theoretical estimate of the total processing time to identify matches between a pair of partitioned log files, and includes several simplifying assumptions. Those of skill in the art will appreciate that more rigorous analyses may be performed, and that the results may be affected by characteristics of the transactions in the log files. An alternative approach to determine whether partitioning of a set of log files will reduce total processing time and an estimate of the level of partitioning that will give good results is an empirical approach in which several test runs of the matching operations at different partitioning levels are performed on all or a subset of the log file data. From the empirical results, a desired level of partitioning may be determined.

Some additional considerations may be that the match window required to perform a matching operation between two log files is so large that memory is exhausted by attempting to keep all required information in memory. In such a situation, a sufficient number of partitioning operations may be required to reduce the match window size so as to not exhaust memory during the matching operations. For a given pair of log files, partitioning may be performed until the partitioned files a smaller than a threshold value. As discussed above, match window size decreases proportionally to file size.

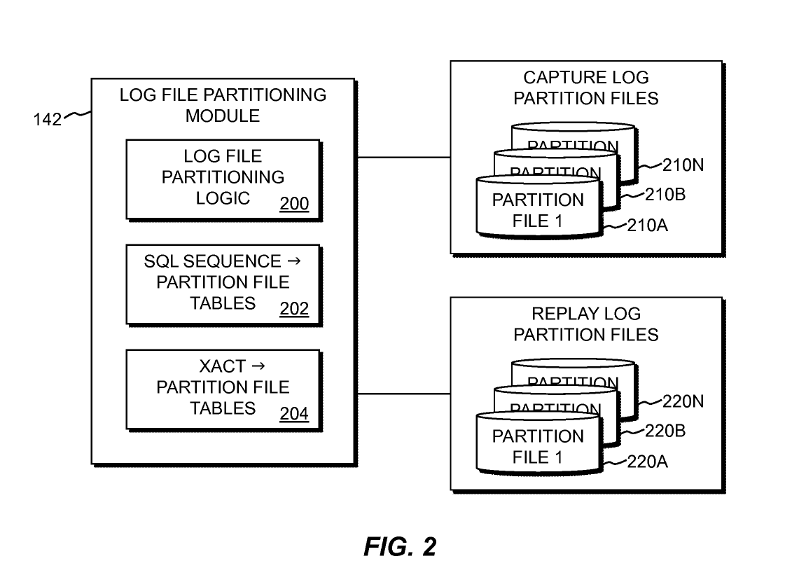

FIG. 2 is a functional block diagram illustrating log file partitioning module 142 in benchmark analysis system 140 of transaction matching system 100, in accordance with an embodiment of the present invention. Log file partitioning module 142 includes log file partitioning logic 200, SQL sequence-to-partition file tables 202, and transaction-to-partition file tables 204. Log file partitioning logic 200 may contain programming code, firmware logic, hardware, or a combination of these, to control the operations associated with performing the log file partitioning modules, in accordance with one or more embodiments of the invention. Capture log partition files 210A-210N and replay log partition files 220A-220N are created and used by log file partitioning module 142.

As will be described in more detail below, log file partitioning logic 200 creates a partition file 210 or 220 for each different beginning sequence of SQL records encountered in the transactions read from the capture file and replay file logs 126. SQL sequence-to-partition file tables 202 include the data stores into which the beginning SQL sequence to partition file ID associations are stored. Each entry in the tables includes the SQL record type identifiers of the sequence and an associated partition file identifier 210 or 220. After a new beginning sequence of SQL records for a transaction is encountered, a new associated partition file 210 or 220 is created and these SQL records are written to the new partition file. All remaining SQL records of the transaction should also be written to the same partition file.

Transaction-to-partition file tables 204 include the data stores into which the transaction ID to partition file associations are stored. Each entry in the tables includes a transaction identifier and an associated partition file identifier 210 or 220. Each entry also includes one or more SQL record information fields to store information for SQL records of a transaction that have not yet been written to a partition file. For example, the transactions in a log file have been split into partition files based on the record types of the first SQL records of the transactions. However, a particular partition file is larger than a threshold value, and will be further split into secondary partition files based on the record types of the second SQL records of the transactions. In one embodiment, the partition file is processed from the beginning, and information from the first SQL record of a transaction is stored in the transaction ID entry in the transaction-to-partition file tables 204 until the second SQL record of the transaction is processed. When the second SQL record of the transaction is processed, it can then be determined into which secondary partition file the SQL records of the transaction will be written. The information for the first SQL record that is stored in the transaction ID entry is written to the just-determined secondary partition file, in the form of a SQL record, along with the second SQL record that is currently being processed. Each table may take the form of an array, a linked list, or another suitable implementation in accordance with an embodiment of the invention.

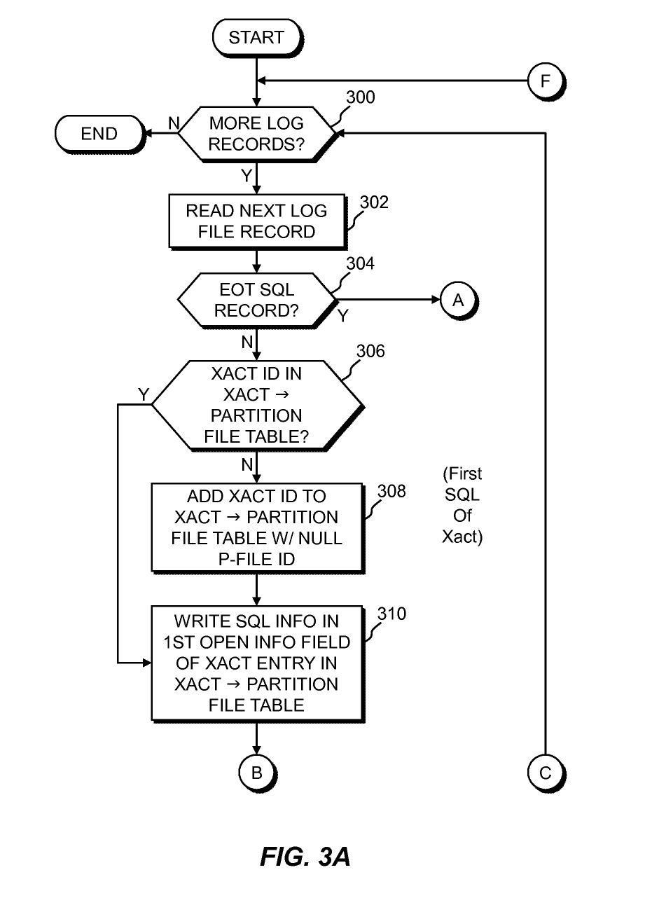

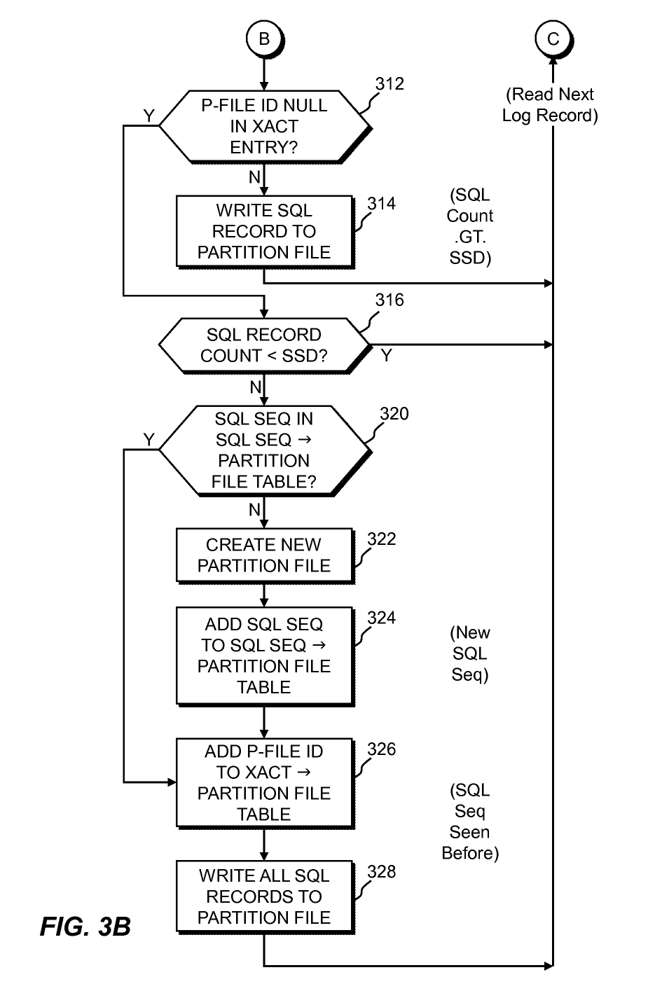

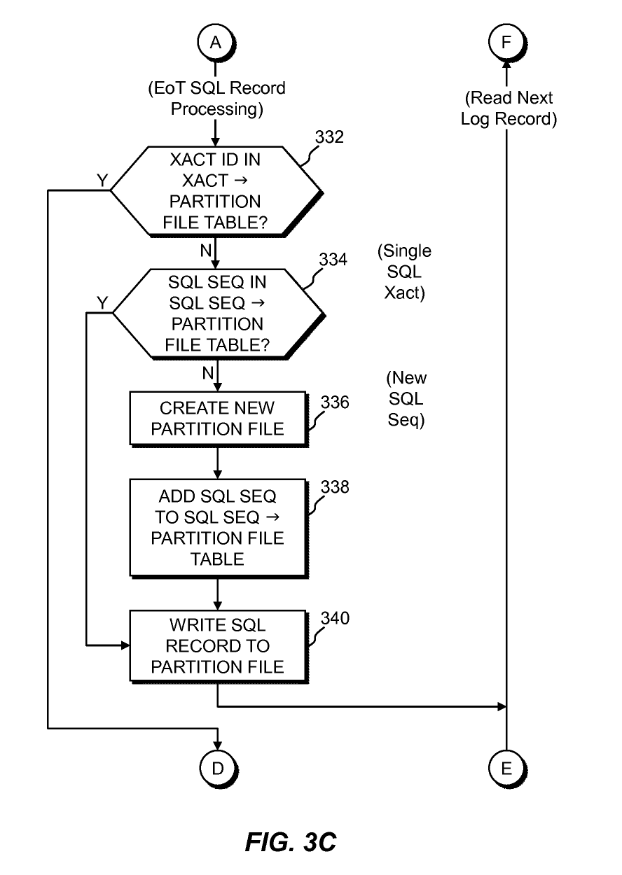

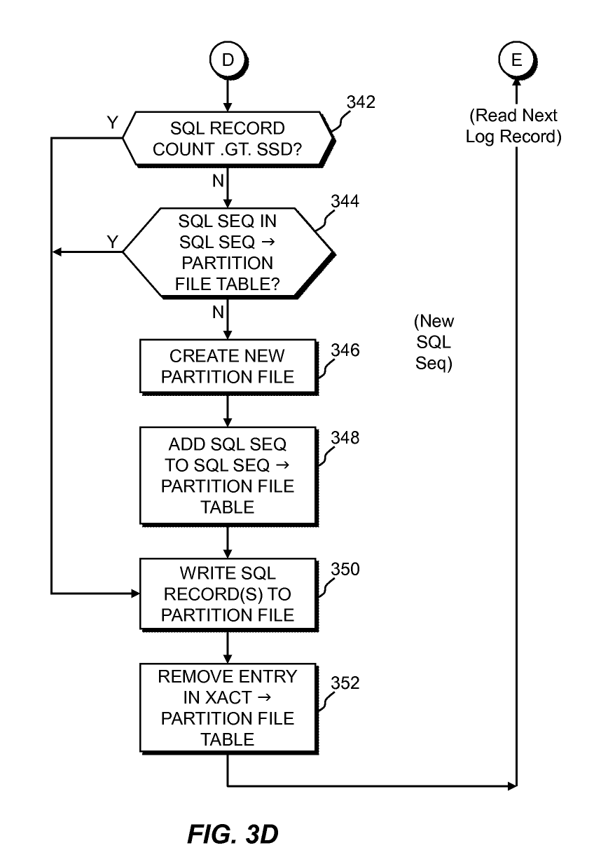

FIGS. 3A-3D is a flowchart depicting the steps that log file partitioning logic 200 may execute, in accordance with an embodiment of the invention. If the last log file record has been processed by log file partitioning logic 200 (decision step 300, “N” branch), then this processing ends. If there are more records in the log file (decision step 300, “Y” branch), log file partitioning logic 200 reads the next record (step 302).

Log file partitioning logic 200 then determines if the log file record, for example, an SQL record of a transaction, is an end-of-transaction (EoT) record (decision step 304). Generally, for non-EoT records, log file partitioning logic 200 identifies new beginning SQL sequences for the transactions in the log file, creates a partition file for each new SQL sequence, and stores the new SQL sequence to partition file association in SQL sequence-to-partition file tables 202. When enough SQL records of a transaction have been read to determine the beginning sequence (which may be the first SQL record, or the first several SQL records, of the transaction), the partition file into which to write the transactions SQL records is determined from the SQL sequence-to-partition file tables 202, and an entry is added to transaction-to-partition file tables 204. Each subsequent SQL record of a transaction beyond the beginning SQL sequence is then written to the partition file indicated in transaction-to-partition file tables 204. Generally, if the SQL record is an EoT record, the record is written to the partition file indicated in transaction-to-partition file tables 204, and the entry in transaction-to-partition file tables 204 is removed. Handling of multi-record beginning SQL sequences, situations where the number of SQL records of a transaction is less than the length of the beginning SQL sequence, and the special case where the first SQL record of a transaction is also an EoT record are explained in more detail below.

If the SQL record is not an EoT record, (decision step 304, “N” branch), then log file partitioning logic 200 determines if the transaction ID of the SQL record has an entry in transaction-to-partition file tables 204 (decision step 306). If there is no entry (decision step 306, “N” branch), then this is the first SQL record of the transaction (and not the EoT record), and an entry is created in transaction-to-partition file tables 204 (step 308), with the partition file ID field in the entry is left blank, or null. The SQL record information, such as, for example, the SQL record start and time, resource usages, variable values, etc., is then written into the first open SQL info field of the new associated transaction entry record in the transaction-to-partition file tables 204 (step 310).

If the transaction ID of the SQL record has an entry in transaction-to-partition file tables 204 (decision step 306, “Y” branch), then the SQL record information is written into the first open SQL info field of the existing associated transaction entry record in the transaction-to-partition file tables 204 (step 310).

Log file partitioning logic 200 then determines if the partition file ID field in the transaction ID entry in the transaction-to-partition file tables 204 is null (decision step 312). If the partition file ID field is not null (decision step 312, “N” branch), this indicates that the SQL record count, i.e., the first, second, third SQL record of the transaction, is greater than the SQL sequence depth value (SDD), the number of records in a unique beginning SQL sequence for which a log file partition record will be created, and the beginning SQL sequence of the transaction will have been associated with a partition file, and the partition file ID of that partition file will have been written to the partition file ID field in the transaction ID entry. The SQL record is then written to the partition file indicated by the partition field of the transaction ID entry in the transaction-to-partition file tables 204 (step 314). The partition file will be associated with all transactions having the same beginning SQL sequence as the current SQL record being processed. After the SQL record is written to the indicated partition file, log file partitioning logic 200 returns to the beginning of this processing and determines if there are additional log file records to process (decision step 300).

If the partition file ID field is null (decision step 312, “Y” branch), this indicates that the SQL record count is less than or equal to the SQL sequence depth value. If the SQL record count is less than the SQL sequence depth value (decision step 316, “Y” branch), log file partitioning logic 200 returns to the beginning of this processing and determines if there are additional log file records to process (decision step 300).

If the SQL record count is not less than the SQL sequence depth value (decision step 316, “N” branch), log file partitioning logic 200 determines if the beginning SQL sequence of the transaction, as indicated by the SQL information fields in the associated entry in transaction-to-partition file tables 204, has an entry in sequence-to-partition file tables 202 (decision step 320). If the beginning SQL sequence of the transaction has an entry in sequence-to-partition file tables 202 (decision step 320, “Y” branch), then the partition file ID from the beginning SQL sequence entry in sequence-to-partition file tables 202 is written to the partition file ID field of the transaction ID entry of the transaction-to-partition file tables 204 (step 326). The SQL information fields in the transaction ID entry of the transaction-to-partition file tables 204 are then written to SQL record formats, which are then written as SQL records to the partition file just associated with the transaction ID; the current SQL record being processed is also written to the partition file (step 328). After the SQL records are written to the partition file, log file partitioning logic 200 returns to the beginning of this processing and determines if there are additional log file records to process (decision step 300).

If the beginning SQL sequence of the transaction does not have an entry in sequence-to-partition file tables 202 (decision step 320, “N” branch), this indicates that the beginning SQL sequence is new. A new partition file is created for the new beginning SQL sequence (step 322), and an entry is added to SQL sequence-to-partition file tables 202 associating the beginning SQL sequence to the newly created partition file (step 324), and the partition file ID from the beginning SQL sequence entry in sequence-to-partition file tables 202 is written to the partition file ID field of the transaction ID entry of the transaction-to-partition file tables 204 (step 326). The SQL information fields in the transaction ID entry of the transaction-to-partition file tables 204 are then written to SQL record formats, which are then written as SQL records to the partition file just associated with the transaction ID; the current SQL record being processed is also written to the partition file (step 328). After the SQL records are written to the partition file, log file partitioning logic 200 returns to the beginning of this processing and determines if there are additional log file records to process (decision step 300).

Returning to the beginning of this processing, if the log file record is an end-of-transaction (EoT) record (decision step 304, “Y” branch), then log file partitioning logic 200 determines if the transaction ID has an entry in the transaction-to-partition file tables 204 (decision step 332). If the transaction ID does not have an entry in the transaction-to-partition file tables 204 (decision step 332, “N” branch), indicating that this EoT SQL record is the only record in the transaction, then log file partitioning logic 200 determines if an entry for this single SQL record beginning sequence has an entry in the sequence-to-partition file tables 202 (decision step 334). If there is an entry for this single SQL record beginning sequence in the sequence-to-partition file tables 202 (decision step 334, “Y” branch), indicating that this single SQL record beginning sequence has been processed before, the SQL record is written to the partition file indicated in the sequence-to-partition file tables 202 (step 340). After the SQL record is written to the partition file, log file partitioning logic 200 returns to the beginning of this processing and determines if there are additional log file records to process (decision step 300).

If there is not an entry for this single SQL record beginning sequence in the sequence-to-partition file tables 202 (decision step 334, “N” branch), then a new partition file is created to store transactions having this single SQL record beginning sequence (step 336). An entry is added to sequence-to-partition file tables 202 associating the single SQL record beginning sequence to the newly created partition file (step 338), and the SQL record is written to the partition file indicated in the sequence-to-partition file tables 202 (step 340). After the SQL record is written to the partition file, log file partitioning logic 200 returns to the beginning of this processing and determines if there are additional log file records to process (decision step 300).

If the transaction ID does have an entry in the transaction-to-partition file tables 204 (decision step 332, “Y” branch), then log file partitioning logic 200 determines if the SQL record count is greater than the SQL sequence depth (decision step 342). If the SQL record count is greater than the SQL sequence depth (decision step 342, “Y” branch), indicating that the beginning SQL sequence has been processed before, and the transaction ID is associated with a partition file, the SQL record being processed is written to the partition file indicated in transaction-to-partition file tables 204 (step 350), and the entry is removed from transaction-to-partition file tables 204 (step 352). After the entry is removed from transaction-to-partition file tables 204, log file partitioning logic 200 returns to the beginning of this processing and determines if there are additional log file records to process (decision step 300).

If the SQL record count is not greater than the SQL sequence depth (decision step 342, “N” branch), indicating that the SQL record count is equal to the SQL sequence depth, log file partitioning logic 200 determines if the beginning SQL sequence has an entry in sequence-to-partition file tables 202 (decision step 344). If the beginning SQL sequence has an entry in sequence-to-partition file tables 202 (decision step 344, “Y” branch), the SQL record being processed is written to the partition file indicated in transaction-to-partition file tables 204 (step 350), and the entry is removed from transaction-to-partition file tables 204 (step 352). After the entry is removed from transaction-to-partition file tables 204, log file partitioning logic 200 returns to the beginning of this processing and determines if there are additional log file records to process (decision step 300).

If the beginning SQL sequence does not have an entry in sequence-to-partition file tables 202 (decision step 344, “N” branch), then a new partition file is created to store transactions having this SQL record beginning sequence (step 346). An entry is added to sequence-to-partition file tables 202 associating the SQL record beginning sequence to the newly created partition file (step 348), the SQL record is written to the partition file indicated in the sequence-to-partition file tables 202 (step 350), and the entry is removed from transaction-to-partition file tables 204 (step 352). After the entry is removed from transaction-to-partition file tables 204, log file partitioning logic 200 returns to the beginning of this processing and determines if there are additional log file records to process (decision step 300).

In certain embodiments, the process represented by the flowchart of FIGS. 3A-3D may be enclosed in another loop that determines if a partition file is larger than a threshold value, and if so, the partition file is split out again, with the SQL sequence depth incremented by, for example, one. For example, if a partition file has a number of SQL records larger than a threshold value, and/or the partition file requires physical storage above a threshold value, the partition file is split out based on the next SQL record types of the transactions in the log file.

In certain embodiments, a mapping is created between corresponding capture and replay partition files such that the records of matching transactions from, for example, capture log partition file(s) and replay log partitioned file(s) occur in the mapped partition files.

In certain embodiments, a comparison can be done to determine that there are, in fact, corresponding partition files between the capture and replay partition files. For example, due to differences in the capture and replay log files, the number of SQL records beginning with a certain SQL record sequence may be much larger in the capture file than in the replay file. Processing of these SQL records in the capture file may result in more partition files, i.e., additional partition file splits, than the corresponding processing in the replay file. In this situation, the associated replay partition file may be split out to the same SQL sequence depth as the capture partition file, even though the replay file is not larger than the predetermined threshold values.

When satisfactory partition files have been created for both the capture and the replay log files, transaction matching module 144 processes corresponding capture and replay partition files, i.e., capture and replay partition files that contain transactions with the same beginning SQL record sequences, and identifies matching transactions for additional benchmark analysis, as desired.

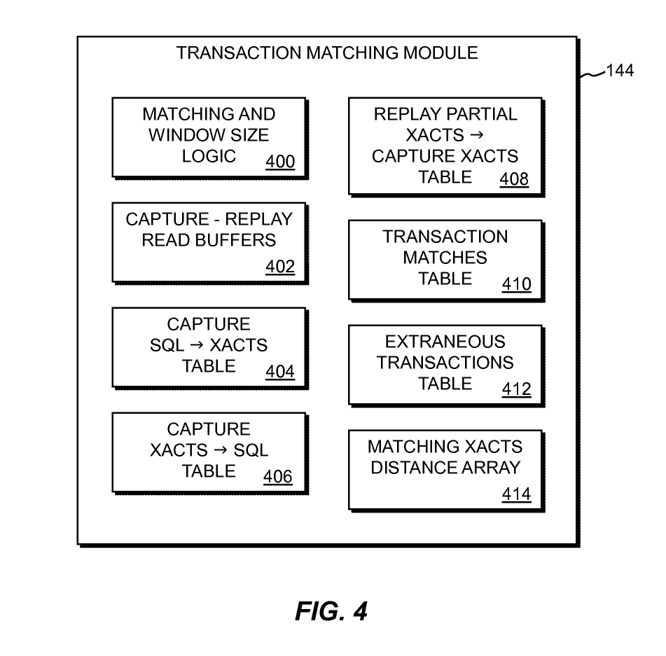

FIG. 4 is a block diagram of transaction matching module 144 in benchmark analysis system 140 of transaction matching system 100, in accordance with an embodiment of the present invention. In an exemplary embodiment, pairs of corresponding capture partition files and replay partition files are processed to identify matching transactions. In certain embodiments, benchmark analysis system 140 may perform two or more transaction matching operations between capture and replay log or partition files concurrently, or in parallel. The matching transactions may then be passed to other modules (not shown) for further analysis. In certain embodiments, matching transactions from each corresponding pair of capture partition files and replay partition files may be passed to the analysis modules as each pair is processed. In other embodiments, this information may be passed when all corresponding pairs of capture partition files and replay partition files have been processed. The description below of the operation of transaction matching module 144 describes how each pair of corresponding capture partition files and replay partition files may be processed. Processing of pairs of corresponding files will typically continue until all pairs have been processed.

Transaction matching module 144 includes matching and window size logic module 400, capture and replay file read buffers 402, capture file SQL-to-transactions table 404, capture file transactions-to-SQL table 406, replay file partial transactions to capture file transactions table 408, transaction matches table 410, extraneous transactions table 412, and matching transactions distance array 414. Matching and window size logic module 400 can contain programming code, firmware logic, hardware, or a combination of these, to control the operations associated with performing the transaction matching operations, including the dynamic match window size adjustment.

Capture and replay file read buffers 402 include the storage into which the transaction SQL records of corresponding capture log or partition files and replay log or partition files are read. In a preferred embodiment, these buffers reside in memory, for example RAM 604, to allow for quick access and manipulation, and are typically implemented as circular buffers. Because the replay file records are processed sequentially and individually, the replay file read buffer does not need to be very long and may be implemented as a single entry buffer. The capture file read buffer should be at least as long as the longest anticipated match window size. In practice, the longest match window size will typically be the initial match window size.

Capture file SQL-to-transactions table 404 will include an entry that maps each SQL record to the transaction to which it belongs as each SQL record is read from the capture log file 126 or a capture partition file 210. Similarly, capture file transactions-to-SQL table 406 will include an entry that maps each transaction to its SQL records as each SQL record is read from the capture log or partition file. As will be described in more detail below, these tables may be used in the mapping of partially read replay file transactions to potential capture file transactions, and, for the SQL records of a capture file transaction that have been read, to identify and flag as extraneous the rest of the records of the transaction when one SQL record of the transaction has been identified as extraneous.

Replay partial transactions to capture transactions table 408 is used by matching and window size logic module 400 to associate partially read replay transactions to potentially matching capture file transactions. Each entry in the table contains a replay transaction identifier and the replay transaction's SQL records read so far, and a capture transaction identifier and the capture transaction's SQL records read so far. For example, a non-end-of-transaction capture file SQL record has been read and is the only capture SQL record of its transaction read so far. A non-end-of-transaction replay file SQL record having the same SQL record type as the capture file SQL record is read. In this scenario, the partial capture file transaction may be a match of the partial replay file transaction, based on their match of SQL record types, and an entry will be added to replay partial transactions to capture transactions table 408 mapping the partial replay file transaction to the partial capture file transaction. As additional capture file and replay file SQL records are read that belong to these respective transactions, the entry for this mapping will be updated until the replay transaction and a capture transaction cannot match. For example, although the first SQL records read for each of the two transactions are the same type, the second SQL records of the transactions may be of different types. When a match is no longer possible, the non-matching capture transaction identifier and its SQL records are removed from the entry. If the non-matching capture transaction identifier was the only capture transaction identifier in the entry, the entire entry is removed from replay partial transactions to capture transactions table 408. Because entries in this table are added based on SQL type, it is possible to have more than one potentially matching capture transaction for a replay transaction, even if all SQL records of the transactions have been read.

Transaction matches table 410 is used to record instances where a capture transaction is identified as matching a replay transaction. As mentioned above, determining a transaction match is performed at the SQL record token level. A capture transaction that in fact corresponds to a replay transaction may not have a complete match of all tokens due to differences in, for example, host variables. Thus, a match between a capture transaction and a replay transaction is declared if the SQL record tokens have a match score above the match score threshold. The match having the highest match score above the match score threshold is identified as a match.

Extraneous transactions table 412 is used in certain embodiments to record transactions in the capture log file 126 or a capture partition file 210 for which no matching transactions are found in the replay log file 126 or a replay partition file 220, and vice versa. In these embodiments, the transaction identifier of each capture file and replay file SQL record that is read is compared against entries in this table. If there is a match, the log or partition file record can be ignored. A transaction in the replay log or partition file will be considered extraneous if a replay SQL record belonging to the transaction does not find a match in the capture file match window having a match score above the match score threshold value. When a replay transaction is identified as extraneous, all references to the transaction are removed from replay partial transactions to capture transactions table 408. A transaction in the capture log file 126 or a capture partition file 210 will be considered extraneous if a capture SQL record belonging to the transaction is not matched to a replay SQL record while the capture SQL record is in the capture file match window, for example, in the active 2K+1 portion of the capture file read buffer 402 and has not been overwritten. When a capture transaction is identified as extraneous, entries that reference the transaction are cleared from capture file SQL-to-transactions table 404, capture file transactions-to-SQL table 406, and replay partial transactions to capture transactions table 408. For embodiments that use extraneous transactions table 412, an entry is added to this table.

Matching transactions distance array 414 is used by matching and window size logic module 400 in determining match window size. In a preferred embodiment, the transaction workload replay and capture file records are first aligned with each other based on, for example, benchmark transaction workload start times. In a controlled database environment in which the benchmark transaction workloads are the only workloads, alignment may be based on the first benchmark transaction workload SQL records in the capture and replay log or partition files. The log file index numbers of the SQL records of the transaction workloads are also normalized. For example, the first SQL record after the transaction workload start time in each file is normalized to an index number of one.

In a preferred embodiment, matching transactions distance array 414 includes an entry that contains the current capture file match window K value, and another entry that contains the maximum actual K value determined from a predefined number of SQL record matches between the replay and capture files. As the first SQL record match of the predefined number of SQL record matches is found, the maximum actual K value entry is set to an initial value, for example, a minimum acceptable K value, or zero. As each transaction match is declared, resulting in the match being recorded in transaction matches table 410, the positive difference in index numbers, for example, the magnitude, or absolute value, of the difference, of each corresponding SQL record of the matching transaction is recorded in the maximum actual K value entry if the positive difference is greater than the current maximum actual K value entry.

When the actual maximum K value has been determined for a predefined number of SQL record matches, a predefined number of transaction matches, or a combination of the two, between the replay and capture files, for example, 500 SQL record matches, or 100 transaction matches, the current capture file match window K value is adjusted, if indicated. In a preferred embodiment, three adjustments are defined. A gross adjustment if there is a large difference between the actual maximum K value and the current K value, a fine tuning adjustment if there is a relatively small difference, and an increase adjustment if the percentage of unmatched transactions is at an unacceptable level. Any adjustment to the current capture file match window K will result in an adjustment to the capture file match window, which is accomplished by adjusting the active 2K+1 portion of the capture file read buffer in capture and replay file read buffers 402.

For the gross adjustment, if the actual maximum K value is, for example, less than one-half the current capture file match window K value, then the current capture file match window K value can be set to, for example, 125% of the of the actual maximum K value. This adjustment may be required for the first adjustment to the initial window size value. For the fine adjustment, if the actual maximum K value is, for example, within 10% of the current capture file match window K value, then the current capture file match window K value can be set to, for example, 115% of the of the actual maximum K value.

A third adjustment can be made if the percentage of unmatched transactions is at an unacceptable value. The percentage of unmatched records can be determined, for example, by comparing the number of capture file transactions declared as extraneous to the number of entries added to transaction matches table 410 during an analysis period. In a controlled environment in which the only transaction workloads recorded in the log files are the benchmark transaction workloads, the acceptable percentage of unmatched transactions can be set to a low value, for example, 2%. In an environment in which there may be a high number of extraneous records in the log files interspersed among the benchmark transaction workloads, the acceptable percentage of unmatched transactions can be set to a higher value.

In another embodiment, each matching transactions distance array 414 entry contains the two index numbers of the corresponding SQL records of the matching transactions recorded in transaction matches table 410. In this embodiment, the array is implemented as a circular buffer with a length equal to the predefined number of SQL matches over which analysis is desired. Analysis of the information in the array can take place as the buffer is rewritten.

In this embodiment, more in-depth statistical analysis can be performed. For example, rather than assuming a record offset of zero between the capture and replay files relative to the aligned and normalized respective index numbers, an offset based on a statistical analysis of all the offsets, such as the average offset, can be determined, and a match window based on, for example, the standard deviation of the distribution of positive and negative matching SQL record distances, can be determined. Generally, for example, a span and offset can be determined by performing an analysis of a statistical distribution of the relative offsets to calculate a mean value of the distribution, and basing the span on a statistical measure of the dispersion about the mean, for example, the variance or standard deviation.

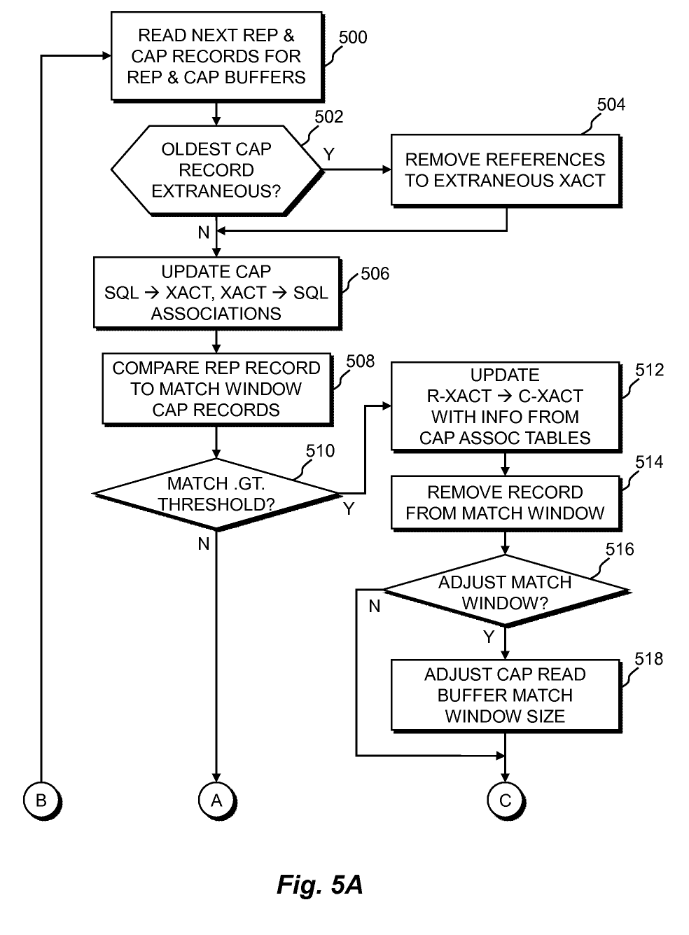

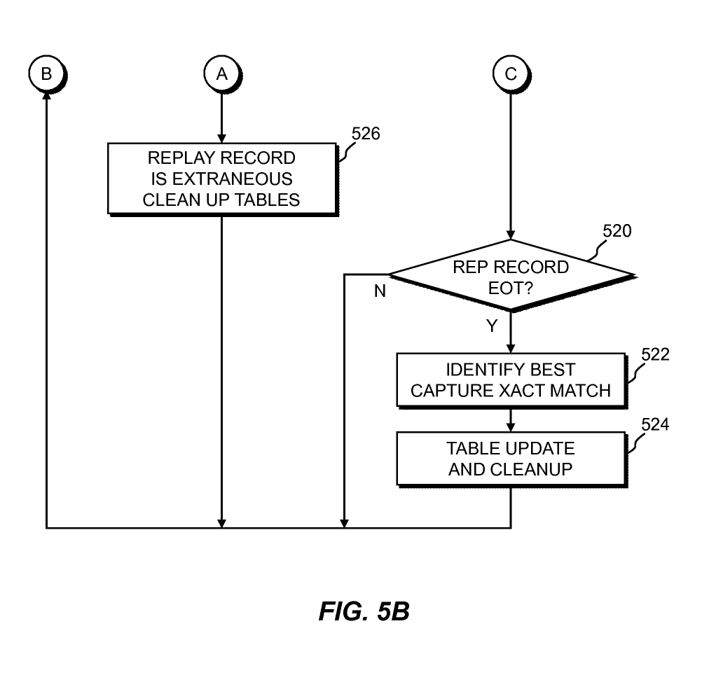

FIGS. 5A and 5B are a flowchart depicting the steps of a transaction matching algorithm, in accordance with an embodiment of the present invention. In the preferred embodiment, the algorithm begins with matching and window size logic module 400 advancing the address pointer for capture file read buffer 402, reading the next replay record from replay record log file 126 or a replay partition file 220 into replay read buffer 402, and the next capture record from the capture log file 126 or a capture partition file 210 for recording into the capture read buffer 402 (step 500). As mentioned above, the active portion of capture read buffer 402 has a length equal to the current match window length of 2K+1. For the first iteration of the algorithm, the first K+1 records are read into capture read buffer 402. After the first K iterations, the capture read buffer 402 will have a full match window of capture log or partition file records.

When the address pointer for capture file read buffer 402 is advanced (see step 500), a determination is made whether the capture file read buffer 402 entry indicated by the address pointer is extraneous (decision step 502). In a preferred embodiment, if the indicated entry contains a SQL record, then the capture transaction to which the SQL record belongs is considered extraneous. As described below, when a capture SQL record within the match window is matched to a replay record, among other actions, the entry in capture read buffer 402 containing the matched SQL record is cleared (see step 514). Thus, if a capture file read buffer 402 entry indicated by the address pointer contains a SQL record, this indicates that the address pointer has come full circle relative to the buffer, and a matching replay file SQL record was not found within 2K+1 replay file records. Because one of the operating assumptions is that a SQL record in the capture file will have a matching record in the replay file, if one exists, within 2K+1 replay file records, the address pointer pointing to an entry containing a SQL record indicates that no match was found, and the transaction to which the SQL record belongs is extraneous.

If the capture file read buffer 402 entry indicated by the address pointer is extraneous (decision step 502, “Y” branch), then entries referencing the capture file transaction are cleared from capture file SQL-to-transactions table 404, capture file transactions-to-SQL table 406, and replay partial transactions to capture transactions table 408 (step 504). For embodiments that use extraneous transactions table 412, an entry is added to this table. The just-read capture file SQL record is then written to the capture file read buffer 402 entry indicated by the address pointer. The capture file SQL-to-transactions table 404 and capture file transactions-to-SQL table 406 are then updated with information from the just-read capture file SQL record (step 506).

The just-read replay file SQL record is then compared to the capture file SQL records in the match window of capture file read buffer 402 (step 508). If a capture file SQL record in the match window is found with a match score greater than the match score threshold value (decision step 510, “Y” branch), indicating at least a partial match, then replay partial transactions to capture transactions table 408 is updated (step 512), and the entry in capture file read buffer 402 containing the matching capture SQL record is cleared (step 514).

Matching and window size logic module 400 then determines if the predefined number of matches have occurred which will trigger an adjustment to the capture file read buffer 402 match window length (decision step 516). If the predefined number of matches has occurred (decision step 516, “Y” branch), then the capture file read buffer match window length is adjusted, as described above (step 518).

If the matching replay record is an end-of-transaction record (decision step 520, “Y” branch), then the best match between the replay transaction to which the end-of-transaction record belongs, and the potential capture transaction matches to this replay transaction contained in replay partial transactions to capture transactions table 408 is determined (step 522). The best transaction match is recorded in transaction matches table 410, and references to the matching replay and capture file transactions are removed from all tables (step 524). Processing then continues with the next replay file and capture file records (step 500).

If a capture file SQL record in the match window is not found with a match score greater than the match score threshold value (decision step 510, “N” branch), then the replay record is considered extraneous, and all references to the replay record and the transaction to which it belongs are removed from replay partial transactions to capture transactions table 408 (step 526). Processing then continues with the next replay file and capture file records (step 500).

FIG. 6 depicts a block diagram of components of the computing device 110 of transaction matching system 100 of FIG. 1, in accordance with an embodiment of the present invention. It should be appreciated that FIG. 6 provides only an illustration of one implementation and does not imply any limitations with regard to the environments in which different embodiments may be implemented. Many modifications to the depicted environment may be made.

Computing device 110 can include one or more processors 602, one or more computer-readable RAMs 604, one or more computer-readable ROMs 606, one or more tangible storage devices 608, device drivers 612, read/write drive or interface 614, and network adapter or interface 616, all interconnected over a communications fabric 618. Communications fabric 618 can be implemented with any architecture designed for passing data and/or control information between processors (such as microprocessors, communications and network processors, etc.), system memory, peripheral devices, and any other hardware components within a system.

One or more operating systems 610, benchmark analysis system 140, transaction processing system 120, and database management system 130 are stored on one or more of the computer-readable tangible storage devices 608 for execution by one or more of the processors 602 via one or more of the respective RAMs 604 (which typically include cache memory). In the illustrated embodiment, each of the computer-readable tangible storage devices 608 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 can also include a R/W drive or interface 614 to read from and write to one or more portable computer-readable tangible storage devices 626. Benchmark analysis system 140, transaction processing system 120, and database management system 130 on computing device 110 can be stored on one or more of the portable computer-readable tangible storage devices 626, read via the respective R/W drive or interface 614 and loaded into the respective computer-readable tangible storage device 608.

Computing device 110 can also include a network adapter or interface 616, such as a TCP/IP adapter card or wireless communication adapter (such as a 4G wireless communication adapter using OFDMA technology). Benchmark analysis system 140, transaction processing system 120, and database management system 130 on computing device 110 can be downloaded to the computing device from an external computer or external storage device via a network (for example, the Internet, a local area network or other, wide area network or wireless network) and network adapter or interface 616. From the network adapter or interface 616, the programs are loaded into the computer-readable tangible storage device 608. The network may comprise copper wires, optical fibers, wireless transmission, routers, firewalls, switches, gateway computers, and/or edge servers.

Computing device 110 can also include a display screen 620, a keyboard or keypad 622, and a computer mouse or touchpad 624. Device drivers 612 interface to display screen 620 for imaging, to keyboard or keypad 622, to computer mouse or touchpad 624, and/or to display screen 620 for pressure sensing of alphanumeric character entry and user selections. The device drivers 612, R/W drive or interface 614 and network adapter or interface 616 can comprise hardware and software (stored in computer-readable tangible storage device 608 and/or ROM 606).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and program product have been disclosed for a presentation control system. However, numerous modifications and substitutions can be made without deviating from the scope of the present invention. Therefore, the present invention has been disclosed by way of example and not limitation.

1-7. (canceled)

8. A computer program product for identifying matching transactions between two log files, first and second log files contain operation records recording executions of operations of transactions in a transaction workload, each operation record having an associated operation record type, each file recording a respective execution of the transaction workload, the computer program product comprising:
one or more computer-readable storage media and program instructions stored on the one or more computer-readable storage media, the program instructions comprising:
program instructions to split the first and second log files into pluralities of corresponding respective first and second partition files, based on distinct sequences of operation record types of a first number of beginning operation records of the transactions in each of the log files;
program instructions to advance one record location at a time, a first record location in a first partition file, and a window of a defined number of sequential second record locations in a corresponding second partition file at a defined record location offset relative to the first record location in the first file;
program instructions to determine whether each operation record of a complete transaction at a first record location has a matching operation record at one of the record locations in the associated window of second record locations;
program instructions, in response to determining that each operation record of a complete transaction at a first record location has a matching operation record in the associated window of second record locations, to identify the complete transaction in the first partition file and the transaction that includes the matching operation records in the corresponding second partition file as matching transactions.

9. A computer program product in accordance with claim 8, further comprising:
program instructions, in response to determine that a partition file is one or more of: larger than a threshold size value, includes a greater number of operations records than a threshold record count value:
to split the partition file into additional partition files based on distinct sequences of operation record types of a second number of beginning operation records of the transactions in each of the log files, the second number being larger than the first number.

10. A computer program product in accordance with claim 8, wherein a complete transaction includes one or more operation records, of which one operation record is an end-of-transaction operation record.

11. A computer program product in accordance with claim 8, wherein the program instructions to determine whether each operation record of a complete transaction at a first record location has a matching operation record at one of the record locations in the associated window of second record locations further comprises:
program instructions to compare tokens in the operation record at the first record location to corresponding tokens in an operation record at a record location in the associated window of second record locations, and, based on token types and token values, determine whether a match exists between the operation record at the first record location an operation record at a record location in the associated window of second record locations based on the number of corresponding tokens that match above a defined match threshold value.

12. A computer program product in accordance with claim 8, further comprising:
program instructions to identify a predefined number of matches between operation records in a first partition file and operation records in a corresponding second partition file, each match identified when a match to an operation record in the first partition file is found in the corresponding second partition file within the current defined number of sequential second record locations in the corresponding second partition file;
program instructions to determine, for the identified matches, the span of the actual range of second record locations in the corresponding second partition file relative to the first locations of the operation records in the first partition file within which all matches were found;
program instructions, in response to determining that the span of the actual range of second record locations is smaller than the current defined number of sequential second record locations by at least a first threshold value, to decrease the current defined number of sequential second record locations;
program instructions, in response to determining that the span of the actual range of second record locations is within a second threshold value of the current defined number of sequential second record locations, to increase the current defined number of sequential second record locations; and
program instructions, in response to determining that an amount above a third threshold value of operation records in the first partition file are not matched to operation records in the corresponding second partition file, to increase the current defined number of sequential second record locations.

13. A computer program product program product in accordance with claim 12, wherein the program instructions to determine the span of the actual range of second record locations in the second file comprises program instructions to determine a statistical measure of the dispersion about the mean value of a statistical distribution of the actual range of second record locations in the corresponding second partition file.

14. A computer program product in accordance with claim 12,
wherein the current defined number of sequential second record locations in the corresponding second partition file is a range of second record locations centered about a record location in the corresponding second partition file corresponding to the first record location of the operation record in the first partition file;
wherein the program instructions to determine the span of the actual range of second record locations in the corresponding second partition file comprises program instructions to determine twice the maximum magnitude of the difference in second record locations between the current defined number of sequential second record locations center record location in the corresponding second partition file and the second record locations of operation records in the corresponding second partition file that match an operation record in the first partition file, plus one; and
wherein increasing and decreasing the current defined number of sequential second record locations comprises increasing and decreasing, respectively, the current defined number of sequential second record locations by an equal number of record locations at the high end and low end of the current defined number of sequential second record locations.

15. A computer system for identifying matching transactions between two log files, first and second log files contain operation records recording executions of operations of transactions in a transaction workload, each operation record having an associated operation record type, each file recording a respective execution of the transaction workload, the computer program product comprising:
one or more computer processors, one or more computer-readable storage media, and program instructions stored on one or more of the computer-readable storage media for execution by at least one of the one or more processors, the program instructions comprising:
program instructions to split the first and second log files into pluralities of corresponding respective first and second partition files, based on distinct sequences of operation record types of a first number of beginning operation records of the transactions in each of the log files;
program instructions to advance one record location at a time, a first record location in a first partition file, and a window of a defined number of sequential second record locations in a corresponding second partition file at a defined record location offset relative to the first record location in the first file;
program instructions to determine whether each operation record of a complete transaction at a first record location has a matching operation record at one of the record locations in the associated window of second record locations;
program instructions, in response to determining that each operation record of a complete transaction at a first record location has a matching operation record in the associated window of second record locations, to identify the complete transaction in the first partition file and the transaction that includes the matching operation records in the corresponding second partition file as matching transactions.

16. A computer system in accordance with claim 15, further comprising:
program instructions, in response to determine that a partition file is one or more of: larger than a threshold size value, includes a greater number of operations records than a threshold record count value:
to split the partition file into additional partition files based on distinct sequences of operation record types of a second number of beginning operation records of the transactions in each of the log files, the second number being larger than the first number.

17. A computer system in accordance with claim 15, wherein a complete transaction includes one or more operation records, of which one operation record is an end-of-transaction operation record.

18. A computer system in accordance with claim 15, wherein the program instructions to determine whether each operation record of a complete transaction at a first record location has a matching operation record at one of the record locations in the associated window of second record locations further comprises:
program instructions to compare tokens in the operation record at the first record location to corresponding tokens in an operation record at a record location in the associated window of second record locations, and, based on token types and token values, determine whether a match exists between the operation record at the first record location an operation record at a record location in the associated window of second record locations based on the number of corresponding tokens that match above a defined match threshold value.

19. A computer system in accordance with claim 15, further comprising:
program instructions to identify a predefined number of matches between operation records in a first partition file and operation records in a corresponding second partition file, each match identified when a match to an operation record in the first partition file is found in the corresponding second partition file within the current defined number of sequential second record locations in the corresponding second partition file;
program instructions to determine, for the identified matches, the span of the actual range of second record locations in the corresponding second partition file relative to the first locations of the operation records in the first partition file within which all matches were found;
program instructions, in response to determining that the span of the actual range of second record locations is smaller than the current defined number of sequential second record locations by at least a first threshold value, to decrease the current defined number of sequential second record locations;
program instructions, in response to determining that the span of the actual range of second record locations is within a second threshold value of the current defined number of sequential second record locations, to increase the current defined number of sequential second record locations; and
program instructions, in response to determining that an amount above a third threshold value of operation records in the first partition file are not matched to operation records in the corresponding second partition file, to increase the current defined number of sequential second record locations.

20. A computer system in accordance with claim 19,
wherein the current defined number of sequential second record locations in the corresponding second partition file is a range of second record locations centered about a record location in the corresponding second partition file corresponding to the first record location of the operation record in the first partition file;
wherein the program instructions to determine the span of the actual range of second record locations in the corresponding second partition file comprises program instructions to determine twice the maximum magnitude of the difference in second record locations between the current defined number of sequential second record locations center record location in the corresponding second partition file and the second record locations of operation records in the corresponding second partition file that match an operation record in the first partition file, plus one; and
wherein increasing and decreasing the current defined number of sequential second record locations comprises increasing and decreasing, respectively, the current defined number of sequential second record locations by an equal number of record locations at the high end and low end of the current defined number of sequential second record locations.
